(19) United States
(12) Patent Application Publication
(10) Pub. No.: US 2003/0095103 A1
(43) Pub. Date: May 22, 2003

(54) Wire keyboard with a wireless transmission receiving end device

(75) Inventors: Nelson Yeh, Taipei (TW); Geng Horng Chung, Tao-Yuan City (TW)

Correspondence Address: BACON & THOMAS, PLLC, 625 SLATERS LANE, FOURTH FLOOR, ALEXANDRIA, VA, 22314

(73) Assignee: High & Hyper Technology Co., Ltd.,, Taipei (TW)

(21) Appl. No.: 09/988,557

(22) Filed: Nov. 20, 2001

(51) Int. Cl. G09G 5/00

(52) U.S. Cl. 345/168

(57) ABSTRACT

A “wire keyboard with a receiving end for wireless transmission” is to use a receiving end circuit provided with a wireless transmission function and incorporates as the same circuit board with the circuit of the wire keyboard body and, after modulizing the electronic network of the receiving end with the wireless transmission function, to incorporate as a single circuit board with the circuit of the wire keyboard body in an inter-link. It is arranged in the interior space in the keyboard frame in order to reduce the manufacturing cost and can resolve a nagging problem of where to place the receiver.

### BACKGROUND OF THE INVENTION

1. Field of the Invention

A wireless transmission type receiver can directly combine with a wire keyboard of a computer.

2. Description of the Related Art

Currently the wireless mouse (B), the wireless keyboard (A) etc. on the market are all provided with a line-out receiver (C), as shown in FIG. 4. One end of this receiver (C) is connected with a host computer (D) and an objective for a wireless transmission is achieved with the wireless keyboard (A) and the wireless mouse (B) using the wireless receiving function. However, because the said receiver (C) is of a wireless transmission the user usually will put the receiver (C) at a place keeping a distance from the host computer (D) and the monitor (E) in order to avoid radiation interference from the host computer (D) and the monitor (E). In this case, a malfunctioned transmission effect will be resulted when the receiver is being used. Shown in FIG. 5 are a wire keyboard board (F), a wireless mouse (B) plus a receiver (C). Its type makes no difference from the former one, that is, to use the wireless mouse (B) for a wireless transmission for the receiver (C) to receive. However, this type still fails to break away from the existing defect so that it is not possible to acquire an effect sufficiently functioned by a wireless product. With the use method of the wire keyboard from this creation, a general customary use can still be kept without worrying about where to put the receiver so as to further avoid the above-mentioned poor result produced accordingly.

### SUMMARY OF THE INVENTION

The main aim for this creation is to hopefully avoid the radiation interference without worrying about where to put the receiver during operating a computer.

One of the aims of this creation is to manipulate the functions as an integrity and to provide the consumer with a cost-saving procurement in order to achieve a popularity of the wireless transmission application.

### BRIEF DESCRIPTION OF THE DRAWINGS

FIG. 1 is a 3-D view of a wire keyboard and a wireless mouse of this creation.

FIG. 2 is a 3-D anatomic presentation of a wire keyboard for this creation.

FIG. 3 is an embodiment of another module for this creation.

FIG. 4 is a 3-D embodiment presentation of a conventional creation.

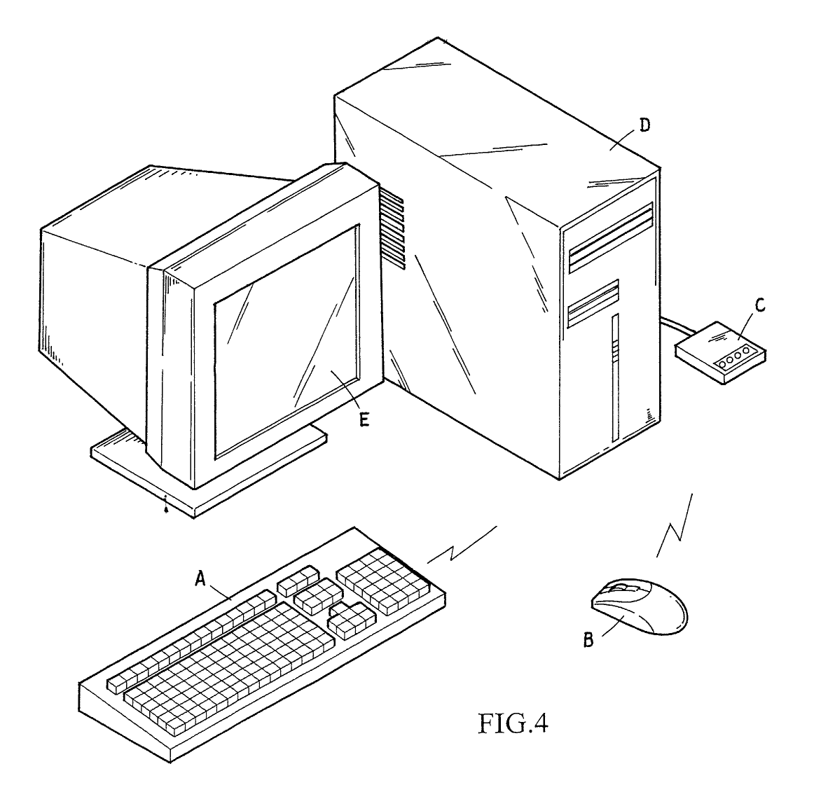

FIG. 5 is a 3-D embodiment presentation of another conventional creation.

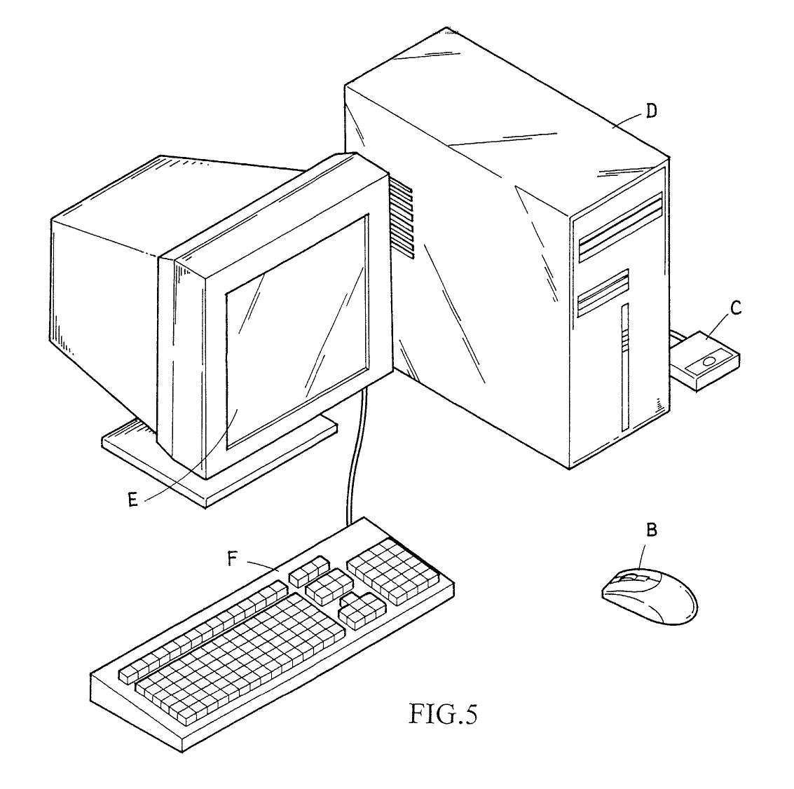

### DETAILED DESCRIPTION OF THE PREFERRED EMBODIMENT

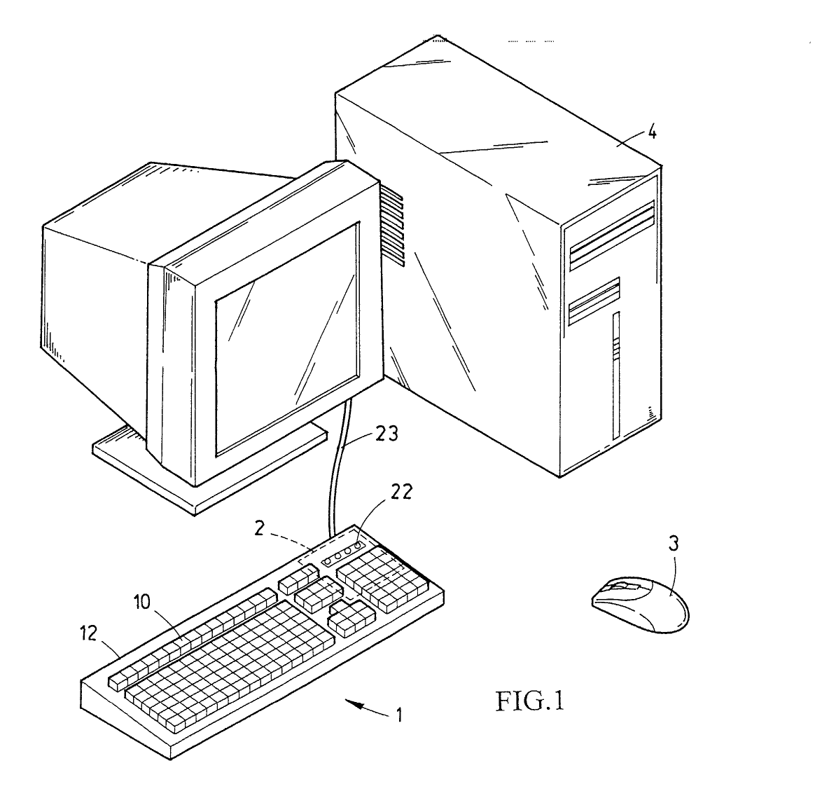

A wire keyboard (1) consists of a button assembly (10), a lower base (11), an upper base (12) and a button circuit and incorporates a control integrated circuit board (2) with a wireless receiving end (21) into a suitable place of the wire keyboard (1). And on the top is provided with a transmitting indication light (22) and on the other end sets a connection line (23), which is divided into a wire keyboard and a connector of a receiving end with a line-out to a computer socket and can connect with a host computer (4). The power supply for its operation is connected to each type of connection interfaces on a host computer (4) system end through the connection line (23) within the wire keyboard (1). The system end directly supplies the type of power supply for the operation, as shown in FIG. 1.

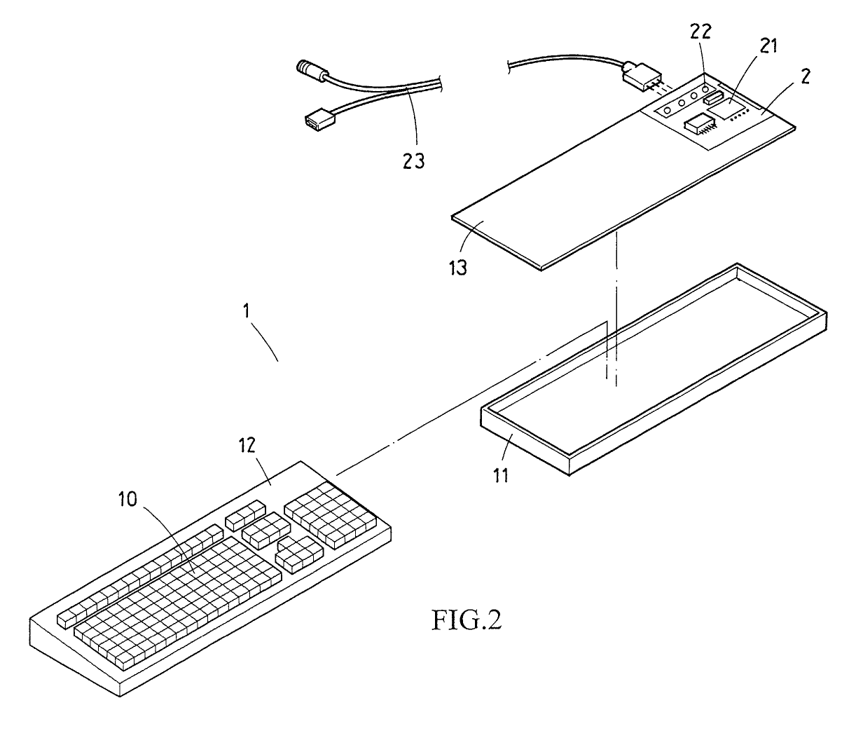

In this way, on the operation of the wire keyboard (1) it is a static operation application and the wireless mouse (3) is a dynamic operation. As a result, when the wireless mouse (3) operates, the transmission signals are delivered to the receiving end (21) in the wire keyboard (1) via wireless transmission. And then the receiving end after processing the signals received will use the connection line (23) to deliver to the host computer (4). The connector of the connection line (23) of the wire keyboard will be directly connected into the host computer (4) and, meantime, can acquire a technological means to manipulate the computer during operation, as shown in FIG. 2.

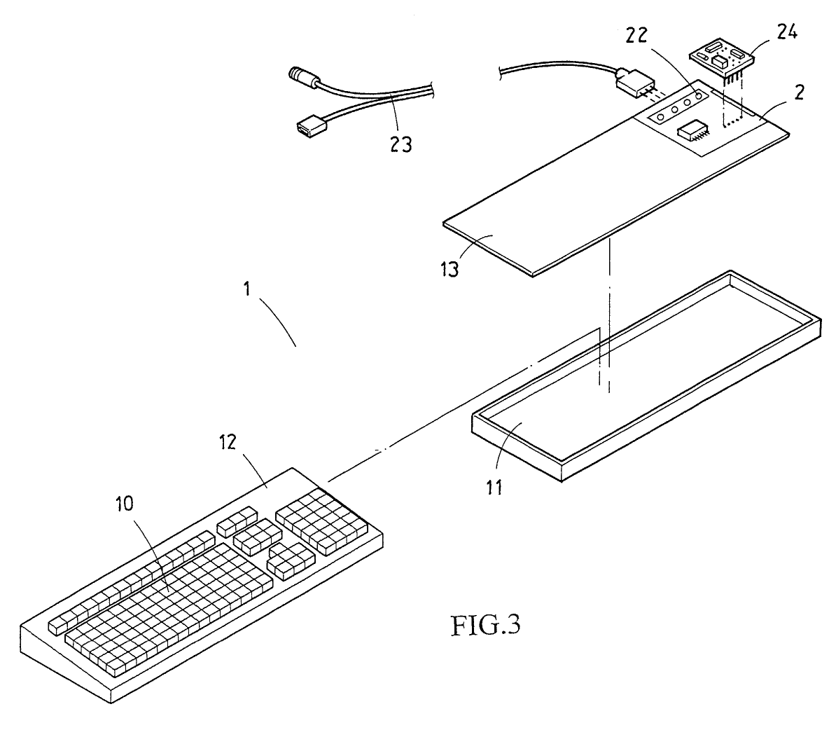

As shown in FIG. 3, it is another embodiment of this creation, which uses the control integrated circuit board (2) within the wire keyboard (1) and adopts a separate manufacturing pattern with the receiving end module (24), i.e., a single circuit board respectively. Between the two an inter-link pattern is produced by means of plugging and soldering. This arrangement is provide more than one set to be incorporated into the wire keyboard (1) with the incorporated area of the receiving end (21) to integrate the transmission of several sets of wireless elements.

To summarize all the above-mentioned, the structure used by this creation has never been heard before and can indeed acquire the effect described above. As a result, with the patent application documents from this invention, the application is thus filed under the law. We will be wholeheartedly grateful if your organization can inspect in detail and grant us the patent.

What is claimed:

1. A “wire keyboard with a receiving end for wireless transmission” consists of:
A host computer;
A wireless mouse;
A wire keyboard; and
A wireless receiving end in the above-mentioned wire keyboard.
Use the circuit assembly of the receiving end of the wireless receiving end and the circuit assembly of the wire keyboard body to integrate as one, a same circuit board assembly, or use the receiving end module of the wireless receiving end and also the circuit assembly of the wire keyboard body to become a single circuit board assembly respectively. Between both a connection method is used by means of inter-link pattern.

2. As said in “wire keyboard with a receiving end for wireless transmission” in item 1 for a patent application scope, in which the above-mentioned wireless end consists of a set or is constructed by using above one set of elements with different features.
